(19) United States
(12) Patent Application Publication
(10) Pub. No.: US 2025/0392147 A1
(43) Pub. Date: Dec. 25, 2025

(54) MULTI-PORT USB POWER CONTROL SYSTEM

(71) Applicant: Textron Aviation, Inc., Wichita, KS (US)

(72) Inventors: Ethan Michael LaForge, Wichita, KS (US); Brian Daniel Shirley, Park City, KS (US); Steven Paul Kurtzweil, Wichita, KS (US)

(21) Appl. No.: 18/750,695

(22) Filed: Jun. 21, 2024

(51) Int. Cl. H02J 7/00

(52) U.S. Cl. CPC H02J 7/0045; H02J 2207/30

(57) ABSTRACT

A system, power allocation method, and device for multi-port universal serial bus power control is provided. The system includes a plurality of power modules, a plurality of charging ports, where each charging port of the plurality of charging ports is connected to a power module of the plurality of power modules, and a controller, where the controller individually and dynamically allocates power to the plurality of power modules.

### TECHNICAL FIELD

The present invention relates generally to an improved system and method for controlling Universal serial bus (USB) charging systems in a vehicle, and, in particular embodiments, to a modular system for unified control of USB charging receptacles in, for example, an aircraft cabin.

### BACKGROUND

Universal serial bus (USB) power outlets in vehicles have become ubiquitous features, catering to the increasing need for device charging on the go. These outlets, typically found in cars, trucks, aircraft, and other vehicles, offer a convenient solution for powering up smartphones, tablets, Global Positioning Satellite (GPS) devices, and other gadgets during journeys. The adoption of USB ports in vehicles reflects the evolving tech-centric lifestyle of modern drivers and passengers, who rely heavily on electronic devices for navigation, communication, and entertainment while traveling. From long road trips to daily commutes, having accessible USB power in vehicles has become a necessity rather than a luxury, ensuring that occupants stay connected and powered up wherever they go.

Moreover, USB power in vehicles has evolved beyond mere convenience, now encompassing fast-charging capabilities and compatibility with various devices. With the introduction of USB-C ports in many newer car models, and in many commercial and private passenger vehicles, users can enjoy faster charging speeds and enhanced power delivery, accommodating the demands of power-hungry devices. These advancements not only streamline the charging process but also promote safety by reducing distractions caused by low battery warnings or the need to fumble with multiple charging adapters.

However, most vehicles have a limited power supply. As power demands increase through both more passengers having devices with power requirements, as well as higher intensity power requirements for individual devices, the need to proportion, prioritize, and dynamically control power delivery among the attached devices has become more of a challenge.

### SUMMARY

In accordance with a preferred embodiment of the presented principles, an improved method of controlling power delivery to a plurality of attached USB devices is provided.

In a first embodiment, a modular universal serial bus (USB) charging system is provided, the system including a plurality of power modules, a plurality of charging ports, where each charging port of the plurality of charging ports is connected to a power module of the plurality of power modules, and a controller, where the controller individually and dynamically allocates power to the plurality of power modules.

In a second embodiment, a universal serial bus (USB) power allocation method is provided, the method including starting, by a controller, a first timer for a first time period, determining if a first input voltage is sufficient to provide a first output threshold voltage, setting a maximum power value for a first power module of a plurality of power modules, based on determining that the first input voltage is not sufficient to provide a first output threshold voltage, to the minimum of either a requested maximum power received in a power request from a first power module of a plurality of power modules or a first default maximum power, setting a maximum power value for the first power module of the plurality of power modules, based on determining that the first input voltage is sufficient to provide a first output threshold voltage, to the requested maximum power received in the power request from the first power module, and generating a power allocation plan based on an available amount of power, a set maximum power value for the first power module of the plurality of power modules, and a set minimum power value for the first power module of the plurality of power modules, and delivering power to the first power module based on the power allocation plan.

In a third embodiment, an aircraft is provided, the aircraft including a plurality of universal serial bus (USB) power modules, a plurality of USB charging ports, where each USB charging port of the plurality of USB charging ports is communicatively and electrically connected to a USB power module of a plurality of USB power modules, where at least a subset of USB charging ports of the plurality of USB charging ports are installed in the aircraft at locations accessible by a passenger or crew of the aircraft, and a controller, where the controller individually and dynamically allocates power to the plurality of USB power modules.

### BRIEF DESCRIPTION OF THE DRAWINGS

For a more complete understanding of the presented principles, and the advantages thereof, reference is now made to the following descriptions taken in conjunction with the accompanying drawings, in which:

FIG. 1 is a block diagram of a modular system for USB power control and delivery according to some embodiments;

FIG. 2 is a logical block diagram of a controller in the modular system for USB power control and delivery, according to some embodiments;

FIG. 3 is a logical block diagram of a power module in the modular system for USB power control and delivery, according to some embodiments;

FIG. 4 is an exemplary initialization method to initialize a controller and enumerate the attached power modules, according to some embodiments;

FIG. 5 is an exemplary power allocation method executed by the controller, according to some embodiments;

FIG. 6 is a device attachment algorithm executed by a power module, in accordance with some embodiments;

FIG. 7 is an exemplary power delivery and renegotiation algorithm executed by a power module 120, according to some embodiments;

FIG. 8 is an exemplary embodiment showing the modular system for USB power control and delivery installed in an aircraft, according to some embodiments; and

FIG. 9 is an electrical diagram of the exemplary embodiment shown in FIG. 8, according to some embodiments.

### DETAILED DESCRIPTION OF ILLUSTRATIVE EMBODIMENTS

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

Embodiments of the presented principles are directed toward providing intelligent load management across multiple USB charging ports to optimize available power, increasing the charging capability and flexibility for customers without necessarily allocating more power to that system.

Certain embodiments of the disclosure are discussed within the context of aircraft USB systems. However, it will be understood that the disclosure is not limited to only aircraft USB systems, and may find uses in watercraft, automobile, or other passenger vehicle USB systems as well. It will also be understood that the embodiments disclosed herein may be used with any aircraft, including fixed wing, rotorcraft, commercial, military, or civilian aircraft. Embodiments of the present disclosure are not limited to any particular setting or application, and embodiments can be used in any setting or application such as with other aircraft, vehicles, or equipment.

Presented herein are USB power delivery electrical modules, for example, included in aircraft seating, that can be modular and customizable for ease of maintenance and construction. Further, elements of the USB power delivery system are modular, such that individual subsystems of the control, delivery, and the like, can be customized based on purchaser desires without having to craft individually customized module for each power requirement or prioritization within a given system. In the event new USB connections are desired, modular components can be added with ease, and without having to redesign the entire platform. The modular nature of the system permits a same control system to be populated with the appropriate modules for a specified USB interface and provide a compatible platform for future systems. Further, with dynamic power delivery, the system can automatically adjust charging rates according to demand, instead of having to build for max power potential (assuming all charging ports are always providing the maximum possible power at all times), resulting is a more scalable system for a same base power supply allotment, and providing intelligent load management across multiple USB charging ports to reduce/optimize overall load. Cost savings can be further achieved through efficiencies of having a common component capable of a range of power delivery customization options.

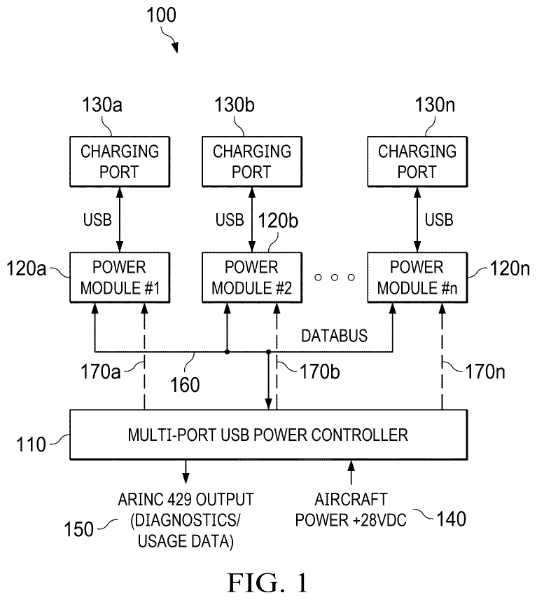

FIG. 1 is a block diagram of a modular system 100 for USB power control and delivery according to some embodiments. The system 100 has one or more controllers 110 responsible for managing and implementing dynamic power delivery to a plurality of USB power modules (120a, 120b, . . . 120n; collectively 120) and associated charging ports (130a, 130b, . . . 130n; collectively 130). In some embodiments, the controller 110 may have a processor and a non-transitory computer readable memory with one or more computer programs, software, or instructions for recognizing, managing, and controlling one or more power modules 120 and charging ports 130. Additionally, the controller 110 may have a processor and a non-transitory computer readable memory with a single computer program, software, or set of instructions with provisions for handling all system modules that may be connected to the system, and the computer program may be updated to account for new modules or capabilities. In other embodiments, the controller 110 may be a centralized system that controls USB systems for multiple USB interfaces, or may be a dedicated circuit such as an application specific integrated circuit (ASIC) with circuitry for controlling the USB systems, or such as a field programmable gate array (FPGA), or the like. For example, the controller 110 may be a microcontroller such as an ATMEGA family microcontroller, an Arduino family microcontroller, Beagleboard system, 8052 or 8088 based microcontroller system, or the like.

The controller 110 may receive input from a power supply 140 in the vehicle. In some embodiments, the power supply may be a +28 VDC power source in an aircraft-based system. In other examples, the power supply 140 may be a +12 VDC battery system, or an alternator system, or the like in the case of combustion or electric vehicles or watercraft. The power supply 140 may comprise AC, DC, rectified AC, rectified and regulated AC to DC power, or the like, and the exact form of the power is not intended to be limiting. The power supply may be powered from a main bus (not shown) of the platform in which the system 100 is located, such as an aircraft main power bus. The main power bus voltage may be stepped down to a suitable voltage for the USB system components by one or more step-down voltage regulators (not shown). The power supply 140 may have a battery backup, either internal or external, to facilitate power to the system 100 while power generation systems are offline.

In some embodiments, the controller 110 may have a data link 150 connecting the controller 110 to other vehicle systems. The data link 150 may include an ARINC 429 in an aircraft, in some embodiments. In some embodiments, the data link 150 may comprise signaling, data lines, or the like, for integration into other vehicle system and/or for receiving and sending diagnostic, usage data, and the like. The controller 110 may also provide usage data (i.e. charging rates, ports used, etc.) for collection by a recording system or other diagnostic or reporting systems.

In some embodiments, the controller 110 can be configured to distribute various pre-determined amounts of power to the system. The configuration method may include grounding to identified connector pins, preconfigured data stored in a memory, jumper pins, or the like. The controller 110 can control power distribution to multiple charging ports 130 through communication with an associated charging port's 130 power module 120 via, for example, a data bus 160, evaluating device charging requests and the charging port 130 priority status against the amount of power available for charging in the system 100. By tracking which charging ports 130 have priority status, and how much power has been requested and is being used by connected charging ports 130, the controller 110 is able to manage and distribute power, through for example, wiring (170a . . . 170n; collectively, 170) between the controller 110 and each power module 120 and in a way that can increase overall customer charging capability and flexibility for customers without needing to allocate more power from the vehicle to the system 100.

In some embodiments, there may be only one associated charging port 130 per power module 120. In some embodiments, each power module 120 may be associated with one or more charging ports 130 such that power to each module is regulated on a per seat, per group, or other combination basis.

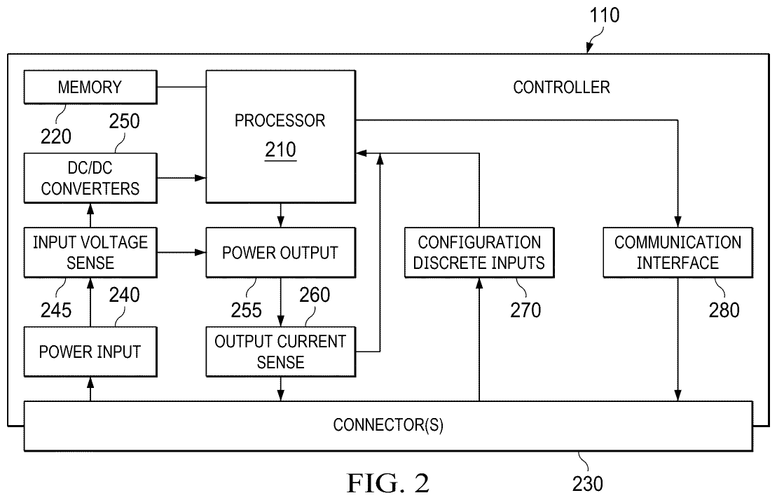

FIG. 2 is a logical block diagram of a controller 110, according to some embodiments. The controller 110 may have at least one first processor 210, one or more first memories 220, one or more first external connector(s) 230 for connection to, among other things, power supplies 140, power modules 120, input/output signaling, a ground plane, and the like.

The at least one first processor 210 may be, for example, a microcontroller, central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The at least one first processor 210 may implement or execute various example logical blocks, modules, and circuits described with reference to content disclosed herein. Alternatively, the first processor 210 may be a combination of processors implementing a computing function, for example, a combination of one or more microcontrollers, microprocessors, or a combination of DSPs and microprocessors or microcontrollers.

The one or more first memories 220 may store computer instructions for implementing the functions described herein, and in some embodiments, an operating system and program code for interacting with one or more of the power modules 120. In some embodiments, all program code necessary to operate a range of potentially installed modules may be pre-loaded in the one or more first memories 220 in order to avoid firmware or software updates when installing or upgrading the system 100 with new functional capabilities. However, in other embodiments, a firmware or software upgrade to the controller 110 may be required to fully enable the new functionality of newly installed or upgraded modules to the system.

The first memories 220 may be one or more memory elements be implemented in any type of volatile or non-volatile storage device or a combination thereof. For example, the first memory 220 may include random access memory (RAM), read-only memory (ROM), static random access memory (SRAM), electrically erasable programmable read-only memory (EEPROM), erasable programmable read-only memory (EPROM), programmable read-only memory (PROM), magnetic memory, flash memory, magnetic disk, optical disc, or the like. In some embodiments, the first memories 220 may be integrated with the first processor(s) 210.

Communications between various devices (including the first processor 210 and first memory 220) may be through a managed or unmanaged bus in the controller 110. The bus may include one or more electrical lines that connect components in the controller 110 to the first processor 210, or first memory 220, for example. In some embodiments, the controller 110 may include one or more receptacles (not shown) for installing additional features to the controller, or for providing communication between the controller 110 and diagnostic tools. In other embodiments, receptacles may be mounting structures or regions on the controller 110 for attaching components, and the bus may be a cable-based bus. For example, wires may be used to connect the first processor 210, or sockets, pins, plugs, or the like, on the controller 110 to other components.

The controller 110 may handle sending and receiving communications through the first external connector(s) 230 using, for example, a master-slave communications protocol, or any other protocol or signaling supported by the controller 110. In other embodiments, processor communications between power modules 120 and the controller 110 may use cabling directly from a power module 120 to the first external connector(s) 230 of the controller 110. Once a module or modules, and the connections necessary to implement a new charging port (or charging ports) 130 on a platform are connected, the controller 110 may automatically recognize the additional module(s) and enable power delivery to the newly installed power module(s) 120 and charging port(s) 130. In some embodiments, a firmware or software upgrade to the controller 110 may be required to fully enable any new functionality of a newly installed or upgraded power module 120.

The first external connector(s) 230 of the controller 110 are designed to securely connect to cabling to power modules such that mechanical jarring, for example, as occurring during turbulence or wave motion, will not dislodge the cabling from the controller 110. However, the receptacles may allow removal of cabling from the controller 110 without requiring solder removal or cutting. Additional fasteners, such as screws, clips, or the like, may be used to further secure the cabling to the controller 110 in some embodiments.

Power delivered from the power supply 140 may enter the controller 110 through the external connectors and may first be processed by first power input circuits 240 of the controller 110. The first power input circuits 240 comprises components and circuit arrangements designed to facilitate the connection of the power supply 140 to the system 100. The first power input circuits 240 regulate, protect, and distribute electrical power effectively to ensure safe and reliable operation of system 100.

The first power input circuits 240 may include protection components such as fuses, breakers, or the like to protect against overcurrent conditions, transient voltage suppressors to protect voltage spikes or transients, reverse polarity protection features, electromagnetic interference (EMI) or radio frequency interference (RFI) filtering components to suppress noise, and one or more voltage regulators. The first power input circuits 240 may include power management integrated circuits (PMICs) and/or power MOSFETs. The first power input circuits 240 provide clean, regulated power through an input voltage sensing circuit 245 to one or more first DC/DC converters 250, and power output circuits 255.

The input voltage sensing circuit 245 monitors and detects the voltage level applied to their input terminals to ensure the safety, reliability, and efficiency of system 100 by continuously monitoring the voltage level applied to their inputs and initiating appropriate actions or responses as necessary, in accordance with some embodiments. For example, the input voltage sensing circuit 245 may provide input to voltage regulators in the first DC/DC converters 250, first power input circuits 240, and/or power output circuits 255. The input voltage sensing circuit 245 may provide input into overvoltage or under voltage protection capabilities of the controller 110, or generate fault detection and system monitoring signaling and/or data. In some embodiments, the input voltage sensing circuit 245 may also measure the available power. For example, where the current is limited by a maximum draw through a fuse or a breaker, a calculation of power available may be made based on the voltage level of the supply voltage detected by the input voltage sensing circuit 245.

First DC/DC converters 250 convert one voltage level of direct current (DC) to another voltage level of DC, in accordance with some embodiments. The first DC/DC converters 250 may include buck converters to step voltages down, boost converters (to step up voltages), buck-boost converters to maintain a constant voltage regardless of variations in input voltage from the power supply 140, flyback converters, forward converters, resonant converters, or the like. First DC/DC converters 250 may be used to provide a variety of voltages necessary to operation of the controller 110, including, for example, +12 VDC and +5 VDC voltage supply lines.

Power output circuits 255 ensure reliable and regulated electrical power to power modules 120 while providing necessary protections and ensuring efficient power transfer, in accordance with some embodiments. Power output circuits 255 may include overcurrent protection components such as fuses, fusible links, circuit breaks or the like. Power output circuits 255 may include overvoltage protection components such as clamping diodes, transient voltage suppressors, or the like. Power output circuits 255 may include voltage regulators such as linear voltage regulators, switching voltage regulators to regulate the power supplied from the controller 110 to each power module 120. The power output circuits 255 may include a plurality of power MOSFETs, power transistors, relays or the like to handle higher power requirements of each of the power modules. For example, in a system having a controller 110 able to support up to 12 attached power modules 120, the power output circuits 255 may include a power MOSFET, power transistor, or relay for each of the 12 potentially attached power modules, so that the power supplied to each of the power modules 120 may be controlled individually. Further, the power output circuits 255 receives control inputs from the first processor 210 to control and/or limit the power delivery to each power module 120.

Regulated power from the output of the power output circuits 255 may be routed through one or more output current sensing circuits 260 before being delivered from the controller 110 to associated power modules 120 through the first external connector(s) 230 and any power distribution cabling or wiring 170 (see FIG. 1) electrically connecting the controller 110 and power modules 120.

Output current sensing circuits 260 monitor and measure the current flowing to each power module and generate signaling and/or data for the processor 210 related to the power delivered to each power module 120, according to some embodiments. Output current sensing circuits 260 may further provide overcurrent protection, closed-loop control, power management, and fault detection capabilities in some embodiments. Output current sensing circuits 260 may further include isolation, filtering, and/or signal conditioning capabilities. Signaling or data from the output current sensing circuits 260 may be used by the first processor 210 to determine if a device is attached to a power module 120 through an associated charging port 130.

The configuration discrete inputs 270 are used to provide configurable inputs to the first processor 210, according to some embodiments. For example, the configuration discrete inputs 270 may include inputs for a maximum available power available to the system, and the like. The configuration discrete inputs 270 may include jumpers, grounding pins, or the like. In some embodiments, the configuration discrete inputs 270 may include information stored in the first memory 220.

A first communication interface 280 facilitates communications between the controller 110 and the power modules 120 to negotiate power delivery over system data bus 160 (FIG. 1). The first communication interface 280 may further support signaling and/or data transfer protocols supporting USB communications between devices attached to charging ports 130 and integrated systems. In some embodiments the integrated systems may include vehicle or platform specific systems, or may include enabling functionality such as ethernet or other packetized protocols, to enable communications external to the platform on which system 100 is installed (e.g., facilitating internet communications, entertainment systems, etc.).

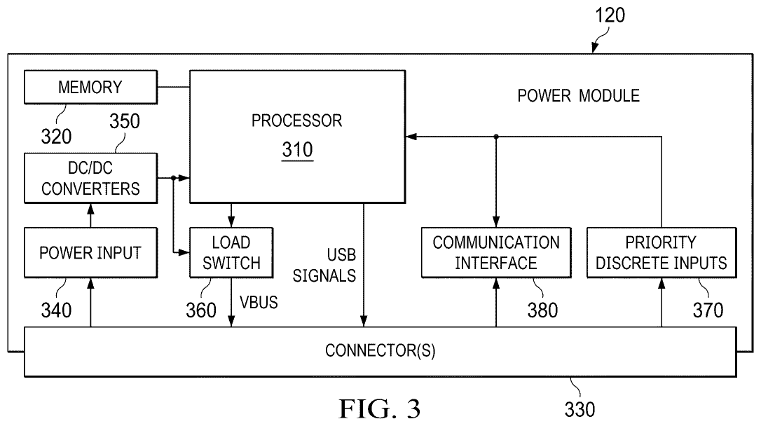

FIG. 3 is a logical block diagram of a power module 120, according to some embodiments. The power module 120 may have at least one second processor 310, one or more second memories 320, one or more second external connector(s) 330 for connection to, among other things, controller 110 and associated charging port(s) 130.

The at least one second processor 310 may be, for example, a microcontroller, central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The at least one second processor 310 may implement or execute various example logical blocks, modules, and circuits described with reference to content disclosed herein. Alternatively, the second processor 310 may be a combination of processors implementing a computing function, for example, a combination of one or more microcontrollers, microprocessors, or a combination of DSPs and microprocessors or microcontrollers.

The one or more second memories 320 may store computer instructions for implementing the functions described herein, and in some embodiments, an operating system and program code for interacting with controller 110. In some embodiments, all program code necessary to operate a range of potentially installed functionality may be pre-loaded in the one or more second memories 320 in order to avoid firmware or software updates when modifying or upgrading the system 100 with new functional capabilities. However, in other embodiments, a firmware or software upgrade to the power module 120 may be required to fully enable the new functionality of newly installed or upgraded modules (e.g., controller 110) to the system.

The second memories 320 may be one or more memory elements be implemented in any type of volatile or non-volatile storage device or a combination thereof. For example, the second memory 320 may include random access memory (RAM), read-only memory (ROM), static random access memory (SRAM), electrically erasable programmable read-only memory (EEPROM), erasable programmable read-only memory (EPROM), programmable read-only memory (PROM), magnetic memory, flash memory, magnetic disk, optical disc, or the like. In some embodiments, the second memories 320 may be integrated with the one or more second processors 310.

Communications between various devices (including the second processor 310 and second memory 320) may be through a managed or unmanaged bus in the power module 120. The bus may include one or more electrical lines that connect components in the power module 120 to the second processor 310, or second memory 320, for example. In some embodiments, the power module 120 may include one or more receptacles (not shown) for installing additional charging port 130 connections, or the like, or for providing communication between the power module 120 and diagnostic tools. In other embodiments, receptacles may be mounting structures or regions on the power module 120 for attaching components, and the bus may be a cable-based bus. For example, wires may be used to connect the second processor 310, or sockets, pins, plugs, or the like, on the power module 120 to other components within the power module 120.

The second external connector(s) 330 of the power module 120 are designed to securely connect to cabling to the controller 110 and charging port(s) 130 such that mechanical jarring, for example as occurring during turbulence or wave motion, will not dislodge the cabling from the power module 120. However, the receptacles may allow removal of cabling from the power module 120 without requiring solder removal or cutting. Additional fasteners, such as screws, clips, or the like, may be used to further secure the cabling to the power module 120 in some embodiments.

Power delivered from the controller 110 may enter the power module 120 through the second external connectors 330 first be processed by second power input circuits 340 in the power module 120. The second power input circuits 340 of the power module may perform a similar function as those in the controller 110, and comprise components and circuit arrangements designed to facilitate the connection of the power from the controller 110 to the power module 120. The second power input circuits 340 regulate, protect, and distribute electrical power effectively to ensure safe and reliable operation of power module 120 and devices attached to associated charging ports 130.

The second power input circuits 340 may include protection components such as fuses, fusible links, breakers, or the like to protect against overcurrent conditions, transient voltage suppressors to protect voltage spikes or transients, reverse polarity protection features, electromagnetic interference (EMI) or radio frequency interference (RFI) filtering components to suppress noise, and one or more voltage regulators. The second power input circuits 340 may include power management integrated circuits (PMICs) and/or power MOSFETs. The second power input circuits 340 provide clean, regulated power to one or more second DC/DC converters 350, and in turn, to the second processor 310 and associated charging port(s) 130 through load switch(s) 360.

Second DC/DC converters 350 convert one voltage level of DC to another voltage level of DC, in accordance with some embodiments. The second DC/DC converters 350 may include buck converters to step voltages down, boost converters (to step up voltages), buck-boost converters to maintain a constant voltage regardless of variations in input voltage from the controller 110, flyback converters, forward converters, resonant converters, or the like. Second DC/DC converters 350 may be used to provide a variety of voltages necessary to operation of the power module 120, including, for example, +12 VDC and +5 VDC voltage supply lines for second processor 310, and power supplied through a USB VBUS line to an associated charging port 130.

The load switch 360 is controlled by the second processor 310 and switches power from an output of a converter of the second DC/DC converters 350 to apply to a VBUS of a USB connection running from the second external connector 330 to an associated charging port 130. When the load switch 360 is open, power from the power module 120 is not provided to the associated charging port 130. When load switch 360 is closed, power from the power module 120 may be provided to the associated charging port 130. Load switch 360 may be a bipolar junction transistor (BJT) switch, a field-effect transistor (FET) switch, an electromechanical relay, a solid-state relay (SSR), a switching diode such as a PIN diode or schottky diode, or the like. In some embodiments, the power module 120 may comprise multiple load switches 360 where the power module 120 controls power delivery to a plurality of associated charging ports 130. In such a case, the power module 120 may have a load switch 360 associated with each charging port 130 connected to an individual power module 120.

The priority input 370 provides a configurable input to the second processor 310 and/or controller 110 (though second communication interface 380 and second external connector(s) 330), according to some embodiments. The priority input 370 designates the power module 120 as either a priority or a non-priority for charging purposes. A priority designated power module 120 may receive additional power to accommodate demands, having higher power charging budgets, or preferentially avoid having power demands limited in high demand situations. For example, power modules 120 associated with charging ports 130 located in the cockpit intended to provide charging power to a pilot, copilot, and/or crew may be prioritized over power modules 120 intended for passenger use (i.e., non-priority designated) in a commercial aircraft setting. In some embodiments, a power module, group of power modules, may be designated as a priority based on the intended user, for example including VIPs, an owner or a chief executive officer of a corporation owning the platform, or the like. The priority input 370 may include jumpers, grounding pins, or the like. In some embodiments, the priority input 370 may include information stored in the second memory 320.

A second communication interface 380 facilitates communications between the power module 120 and controller 110 to negotiate power deliver over system data bus 160 (FIG. 1). The second communication interface 380 may further support signaling and/or data transfer protocols supporting USB communications between devices attached to charging ports 130 and integrated systems. In some embodiments the integrated systems may include vehicle or platform specific systems, or may include enabling functionality such as ethernet or other packetized protocols, to enable communications external to the platform on which system 100 is installed (e.g., facilitating internet communications, entertainment systems, etc.).

In some embodiments, power modules 120 may further include input voltage sensing circuits (not shown), similar in function and operation to the input voltage sensing circuit 245 of the controller 110. In some embodiments, power modules 120 may include VBUS output current sensing circuits (not shown) to measure the output current supplied on the USB VBUS line to an attached device, similar to the output current sensing circuits 260 in the controller 110.

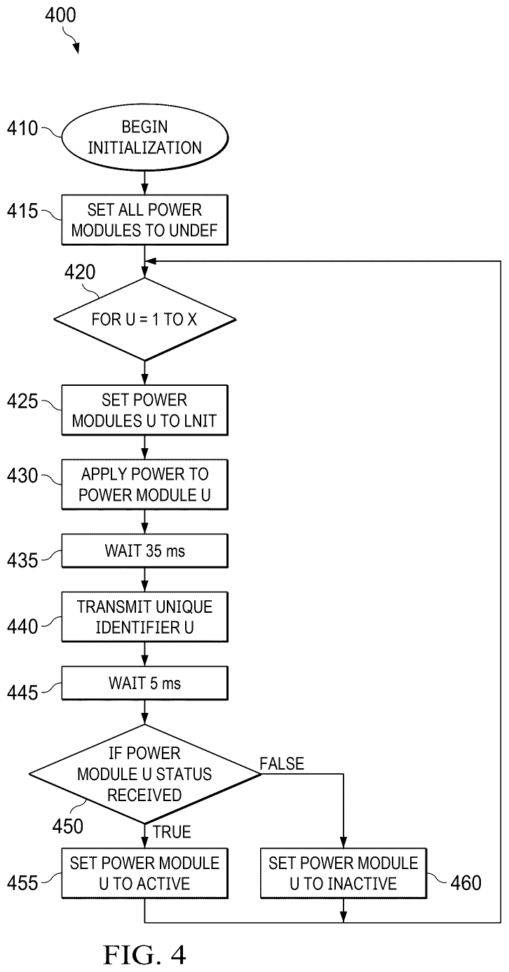

FIG. 4 is an exemplary initialization method 400 to initialize controller 110 and enumerate the attached power modules 120, according to some embodiments. In block 410, the controller 110 is first powered up and first processor 210 may access the initialization routines stored in first memory 220. In some embodiments, there may be additional start-up diagnostics, initialization routines, system checks, or the like further included in the controller startup.

In block 415, the controller 110 may initialize a data structure related to power modules to an undefined state. The undefined state may be NULL or may be another data representation indicated that the status of a power module 120 is unknown. The data structure may be stored in either a volatile or non-volatile memory of first memory 220 of the controller 110.

In block 420, the controller initializes a loop variable U in FIG. 4 to iterate from 1 to X in integer units, where X is a total number power modules 120 supportable by the controller 110, according to some embodiments. In other embodiments, the loop variable may be configured to loop to a known number of connected power modules 120 either set though configurable inputs 270, or stored in a non-volatile memory of first memories 220.

In block 425, the controller 110 will set the data structure for a power module 120 attached to a first port in the first external connector to indicate that the initialization procedure is being executed for that power module 120. The first port may be hardcoded into controller 110, such that the routine sequences though ports in a predetermined manner based on their physical address, according to some embodiments. In other embodiments, virtual addressing or ports in first external connector 230 may be used to allow for configuration of the sequencing through ports. The mapping of virtual to physical address may be stored in first memory 220. Any method of abstracting physical addresses may be used (e.g., e.g., a linked list, mapping table, stack, etc.).

In block 430, the controller 110 applies power to power module 120 through the first port in the first external connector 230. For example, in relation to FIG. 1, where power module 120a is the first to be initialized, power will be applied to power line 170a between the controller 110 and power module 120a. This may be accomplished though the first processor 210 signaling a specific power MOSFET, power transistor, or relay in power output circuits 255 to turn on, providing power through the first external connectors 230 to a specific power line 170 for a specific power module 120.

In block 435, the controller 110 waits a first time period. This allows the power module 120 to power up and stabilize before sending signaling to the power module 120. In some embodiments, the first time period may be about 35 milliseconds (ms). For the purposes of this disclosure “about” means within +/−10%.

In block 440, the controller 110 may transmit though data bus 160 a unique identifier to the power module 120 being initialized (e.g., power module 120a in the first iteration of loop variable U). In some embodiments, such as the embodiment shown in FIG. 1, the power modules 120 and the controller 110 share a common data bus 160. In such embodiments, each power module 120 needs a locally unique identifier so the controller 110 can differentiate power requests/status messages from different modules 120. In some embodiments, the unique identifier may be configured with pin strapping at each power module 120, a globally unique ID may be hardcoded in each module, determined based on an assigned number of a power pinout on the controller 110 to which each individual power module 120 is connected.

In block 445, the controller 110 waits a second time period to receive a response from the power module 120 being initialized (e.g., power module 120a in the first iteration of loop variable U). In some embodiments, the second time period may be about 5 milliseconds.

In block 450, if the controller receives a response from the power module 120 being initialized (e.g., power module 120a in the first iteration of loop variable U) before the second time period elapses, block 455 is performed and the controller 110 may set the data structure related to power module 120 being initialized (e.g., power module 120a in the first iteration of loop variable U) to indicate that the power module 120 being initialized is active. If the controller does not receive a response from the power module 120 being initialized (e.g., power module 120a in the first iteration of loop variable U) before the second time period elapses, block 460 is performed and the controller 110 may set the data structure related to power module 120 being initialized (e.g., power module 120a in the first iteration of loop variable U) to indicate that the power module 120 being initialized is inactive (e.g., not working properly, not connected or installed, or the like).

After executing either block 455 or block 460, the controller will progress back to block 420, increment the loop variable U, and perform blocks 420 through 450 and either block 455 or block 460 for each integer value of U up to X (the total number power modules 120 supportable by the controller 110 or the total number power modules 120 configured as connected), such that all power modules are tested and determined to either be active or inactive.

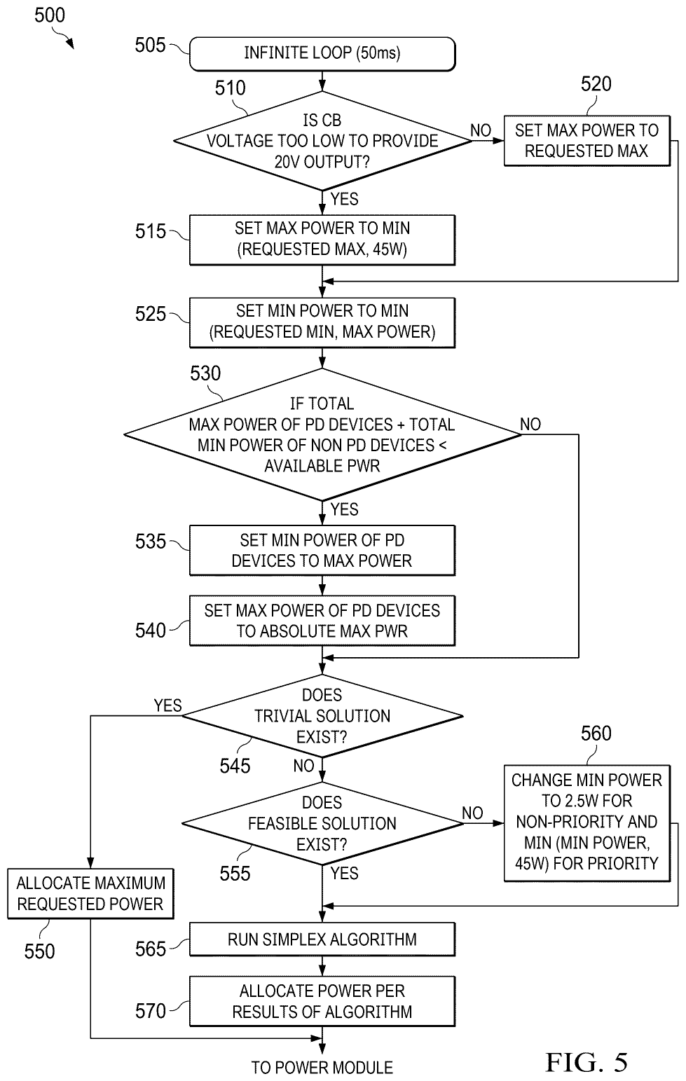

FIG. 5 is an exemplary power allocation method 500 executed by the controller 110, according to some embodiments. In some embodiments, as shown in block 505, the power allocation method may be executed in an infinite repeating loop based on a third time period. For example, in some embodiments, the controller 110 may start a timer at the beginning of executing the power allocation method 500. At the latter of the timer reaching the third time period, or finishing the previous execution of the power allocation method 500, the controller 110 may again begin a further iteration of the power allocation method 500. In some embodiments the third time period may be 50 ms. The power allocation method may not be started until after the controller 110 completes the initialization method 400, in some embodiments. The controller 110 will receive and store power requests from attached power modules 120 (on behalf of devices connected to them through the associated charging port(s) 130) outside and independent of execution of the power allocation method 500. Accordingly, new request for power from a power module may require waiting until a subsequent execution of the power allocation method 500 before being fulfilled by the controller 110.

In block 510, a check is performed to determine if circuit breaker (CB) voltage is too low to provide a first threshold output voltage. In some embodiments the first threshold output voltage may be +20 VDC. In some embodiments, power module 120 may use a step-down converter to produce the voltage applied to the VBUS line to power an attached device through the associated charging port 130. Accordingly, if the voltage applied to the VBUS line is negotiated to be 20V, the input voltage must be slightly higher than 20V due to the minimum dropout of the converter to avoid violating the minimum VBUS voltage and triggering a USB fault. Because of voltage drops between the voltage measured at the controller 110 and a power module 120 input, the actual threshold for disabling 20V output (>45 W) may be chosen to be a few volts above the minimum dropout of the converter. Further power fluctuations during procedures such as engine start, may result in, for example, a 28V bus on the aircraft dropping as low as 18V during such transients. In such cases, the voltage applied to the VBUS line may be lowered, or output to the power modules 120 suspended if voltage drops below an absolute minimum threshold voltage.

If the CB voltage is insufficient to provide the first threshold output voltage (block 510 check results in a determination that CB voltage is too low) then block 515 is performed. In block 515, for each power module 120 from which a power request has been stored (described further below), the controller 110 sets a maximum power value to the minimum of an either the requested maximum power or a first maximum power limit. In some embodiments, the first maximum power limit may be 45 watts (W). The controller 110 will then progress to block 525. For example, if the device requests a maximum power of 100 W, but the first maximum power limit is 45 W, the controller 110 will set the maximum power for that power module 120 to 45 W. Alternatively, if the device requests a maximum power of 30 W, and the first maximum power limit is still 45 W, the controller 110 will set the maximum power for that power module 120 to the 30 W requested maximum power.

If the CB voltage is sufficient to provide the first threshold output voltage (block 510 check results in a determination that CB voltage high enough) then block 520 is performed. In block 520, for each power module 120 from which a power request has been stored (described further below), the controller 110 sets the maximum power value to the maximum power requested from the power module 120. The controller will then progress to block 525.

In block 525, the controller 110 sets a minimum power for each power module 120 from which a power request has been stored to the minimum of the minimum value received in the power request from that power module 120 or a maximum power that could be feasibly allocated by to the power module 120. For example, if a device requested a minimum power of 1000 W (request minimum power), but the power module can only handle 90 W total (maximum power that could feasibly be allocated), the minimum power for the power module set by the controller 110 will be 90 W. Alternatively, if the device requests a minimum power of 10 W, and the power module 120 can still handle 90 W, the minimum power for the power module set by the controller 110 will be the requested 10 W minimum.

In block 530, the controller 110 will then calculate a first total power that is the sum of the maximum power requests for any power module 120 that has been designated as a power delivery device and the minimum power requests for all power modules 120 that have not been currently designated as power delivery devices (or designated non-power delivery). For example, non-power delivery power modules 120 may have devices attached using a USB 2.0 protocol, or may be a USB 3.0 device that draws less than 15 W, and thus does not require power delivery negotiation set the voltage applied to the VBUS line over 5.0 VDC. The controller 110 will then check to see if the total is less than an available power. Available power is defined as the CB voltage times the CB current rating*a safety margin (SM) (Pₐᵥₐᵢₗ=V_{CB}×I_{CB}×SM). In some embodiments the safety margin may be 0.8 to avoid exceeding 80% of a circuit breaker rating. The CB current rating (I_{CB}) may be coded into a memory 220 of the controller 110, may be determined by pin strappings in the configuration discrete inputs 270, or the like. If the first total power is less than the available power, then the controller 110 will execute blocks 535 and 540. If the first total power is not less than the available power then the controller 110 will skip ahead to block 545.

In block 535, the controller 110 will set the minimum power value for all power modules 120 that are designated as power delivery power modules (meaning having a device connected through an associated charging port 130 where the device requests a VBUS line voltage greater than 5.0 VDC, or the device requires more than 15 W charging capacity) to the maximum power determined in blocks 515 or 520. In block 540, the controller 110 will set the maximum power value for all power modules 120 that are designated as power delivery power modules to a maximum power that the particular power module is capable of providing. In some embodiments, the maximum power each power module 120 is capable of handling may be uniform across all power modules 120 installed in the platform or vehicle. In some embodiments, the maximum power each power module 120 is capable of handling may be different for different power modules 120 installed in the platform or vehicle. In some embodiments, the maximum power each power module 120 is capable of handling may be preconfigured either in first memory 220, set through configuration inputs 270, or stored in second memory 320 and sent to the controller as part of the initialization method 400, the device attachment algorithm 600, or another procedure executed by each power module 120.

The check in blocks 530, 535, and 540 are intended to avoid an over power situation where a device attached to a charging port 130 reports a power requirement far below the power required to charge that device's battery. Accordingly, the algorithm checks to determine if power can still be delivered if all attached devices attempt to draw power exceeding their maximum reported power requirement. In some embodiments, blocks 530, 535, and 540 may be eliminated where, for example, devices are tested for compliance with protocols before being allowed to be connected to the system.

In block 545, the controller 110 checks to determine if a trivial solution exists. For example, if the available power is greater than the sum of the maximum power for each power module 120, then the controller 110 executes block 550 and may allocate the maximum power to each power module 120.

If a trivial solution does not exist, block 555 is executed to check for a feasible solution based on the maximum and minimum power requests/set values for each power module. For example, when the sum of the maximum power for each power module 120 designated as a priority module and the sum of the minimum power for each power module 120 designated as non-priority is less than the available power, then the controller 110 may proceed to block 565.

If a feasible power solution does not exist, for example when sum of minimum power for all power modules 120 exceeds the available power, the controller may execute block 560. In block 560, the controller 110 may set the minimum power for all non-priority designated power modules 120 to a first minimum power threshold. In some embodiments the first minimum power threshold may be 2.5 W. Additionally, the controller 110 will override the minimum requested power for all priority designated power modules 120 to the minimum of a second minimum power threshold or a minimum requested power. In some embodiments, the second minimum power threshold may be a multiple of the first minimum power threshold. In some embodiments the second minimum power threshold may be a power limit higher than the first minimum power threshold, such as 45 W. The controller 110 will then progress to block 565.

In block 565, the controller 110 runs a simplex algorithm to determine power plan to allocate power to the connected power modules 120. A variety of algorithms may be used to allocate power among the power modules 120 that may or may not rely on specific communications with a connected user device. For example, an EXTENDED_SINK_CAP message may be sent to the connected user device that includes information indicating the intended charging power of the device. Thus, the specific algorithm may depend on the information that is solicited from attached user devices, and the level of knowledge of the system about connected user device capabilities. Further, in some embodiments, power may be removed from a module with a connected device that attempts or does draw more than an allocated power amount. However, in an embodiment, the simplex algorithm may include the following.

The controller 110 may first calculate if each power module may be delivered its maximum operational power using the following equation:

$${P}_{avail} - \sum {P}_{MAX - i} \geq o ,$$

where Pₐᵥₐᵢₗ is a total available power (described in relation to block 530 above), P_{MAX-i} is a maximum operational power for a specific power module [i], i is a iterative integer from 1 to the number of power modules (N) (i=[1, . . . , N]), and ΣP_{MAX-i} is the sum of the maximum operational power for all power modules 120 with user devices attached though an associated charging port 130. If the above equation is true, the system has an excess amount of power available and maximum operational power may be delivered to each power module 120. If the equation is not true, then the system is power constrained, and reductions in the amount of power delivered to power modules 120, below the maximum operational power of at least a subset of the power modules 120, need to be made.

The controller 110 may then determine if the system is severely power constrained by testing the following equation:

$${P}_{avial} - \sum {P}_{min - i} < o ,$$

where Pₐᵥₐᵢₗ is again the total available power (described in relation to block 530 above), Pₘᵢₙ₋ᵢ is a minimum requested operational power for a specific power module [i] based on the attached devices, i is a iterative integer from 1 to the number of power modules (N) (i=[1, . . . , N]), and ΣPₘᵢₙ₋ᵢ is the sum of the minimum requested operational power for all power modules 120. If this is true, then the controller 110 will set the minimum requested power for all non-priority power modules 120 to the first minimum threshold power (e.g., 2.5 W), and the minimum requested power for all priority modules to the second minimum threshold power (e.g., 45 W). If Pₐᵥᵢₐₗ−ΣPₘᵢₙ₋ᵢ is still less than 0, then no solution exists, and power allocation will be removed from power modules, starting with non-priority power modules until Pₐᵥᵢₐₗ−ΣPₘᵢₙ₋ᵢ is greater than or equal to zero.

In the event that the following is true, then the system is power constrained, but a solution exists:

$${P}_{avail} - \sum {P}_{MAX - i} < o , and$$

$${P}_{avial} - \sum {P}_{min - i} > o .$$

In this case, one potential embodiment for allocating power may consist of starting with assigning each power module 120 with its minimum power and then iteratively assigning power from a pool of available power to power modules with a highest weight factor (C). For instance, a normalized power (V) for each power module 120 may be determined according to the following equation:

$${V}_{i} = {C}_{i} {W}_{i} where {C}_{i} = \frac{{V}_{M}}{{P}_{MAX - i}} * {B}_{i} ,$$

where Vᵢ is the normalized power for a particular power module 120 [i], Cᵢ is the weight factor for a particular power modules 120 [i], Wᵢ is the power allocated to a particular power module 120 [i], V_{M} corresponds to the maximum request power allocated and is the same for all power modules, and Bᵢ is a bias coefficient 0 adjust the weight of a power module 120 [i], for instance to account for battery SoC, measured power, or priority/non-priority status.

The controller may then attempt to maximize a sum of the normalize power of all power modules 120 (Z=ΣVᵢ), subject to the following constraints:

$$\sum {W}_{i} \leq {P}_{avail}$$

$${W}_{i} \leq {P}_{MAX - i}$$

Wᵢ≥Pₘᵢₙ₋ᵢ owever, these constrains must be turned into a standard form first, and slack variables may be introduced. The slack variables convert inequality constraints into equalities which can then be solved for by the controller 110. The slack variables make up the difference between the inequality boundary and the actual value. The result is as follows:

$$Z - \sum {V}_{i} = 0 ,$$

$$\sum {W}_{i} + {S}_{t} = {P}_{avail} ,$$

$${W}_{i} + {S}_{i} = {P}_{Max - i} ,$$

and
Wᵢ−Yᵢ=Pₘᵢₙ₋ᵢ herein Sₜ, Sᵢ, and Yᵢ are the slack variables. Solving for Wᵢ in the last equation, and substituting that into the other three equations results in the following three equations:

$$Z - \sum {C}_{i} {Y}_{i} = \sum {C}_{i} {P}_{min - i} \sum Y\_i + S \_t = P\_avail - \sum P\_ ( min - i )$$

Yᵢ+Sᵢ=P_{MAX-i}−Pₘᵢₙ₋ᵢ an example where there are 3 power modules (N=3), maximum request power allocated is 10000 (Vₘ=10000), maximum power available is 100 W (Pₐᵥₐᵢₗ=100), requested maximum power of power module 1 is 100 W (P_{MAX-1}=100), requested minimum power of power module 1 is 30 W (Pₘᵢₙ₋₁=30), requested maximum power of power module 2 is 60 W (P_{MAX-2}=60), requested minimum power of power module 2 is 15 W (Pₘᵢₙ₋₂=15), requested maximum power of power module 3 is 15 W (P_{MAX-3}=15), and requested maximum power of power module 3 is 7 W (Pₘᵢₙ₋₃=7), the following equations and matrix can be created:

$$Z - {C}_{1} {Y}_{1} - {C}_{2} {Y}_{2} - {C}_{3} {Y}_{3} = {C}_{1} {P}_{min - 1} + {C}_{2} {P}_{min - 2} + {C}_{3} {P}_{min - 3} \_ 2 + Y\_ 3 + S\_t = P\_Mt - P\_m 1 - P\_m 2 - P\_m 3 ,$$

$${Y}_{1} + {S}_{1} = {P}_{M 1} - {P}_{m 1} ,$$

$${Y}_{2} + {S}_{2} = {P}_{M 2} - {P}_{m 2} , and$$

$${Y}_{3} + {S}_{3} = {P}_{M 3} - {P}_{m 3} .$$

TABLE 1

| Y₁ | Y₂ | Y₃ | S₁ | S₂ | S₃ | Sₜ | Z | |
|---|---|---|---|---|---|---|---|---|
| 1 | 0 | 0 | 1 | 0 | 0 | 0 | 0 | P_{MAX-1} − Pₘᵢₙ₋₁ |
| 0 | 1 | 0 | 0 | 1 | 0 | 0 | 0 | P_{MAX-2} − Pₘᵢₙ₋₂ |
| 0 | 0 | 1 | 0 | 0 | 1 | 0 | 0 | P_{MAX-3} − Pₘᵢₙ₋₃ |
| 1 | 1 | 1 | 0 | 0 | 0 | 1 | 0 | Pₐᵥₐᵢₗ − Pₘᵢₙ₋₁ − Pₘᵢₙ₋₂ − Pₘᵢₙ₋₃ |
| −C₁ | −C₂ | −C₃ | 0 | 0 | 0 | 0 | 1 | C_1 P_(min − 1) + C_2 P_(min − 2) + |
| | | | | | | | | C_3 P_(min − 3) |

From this point on, values may be plugged in to the matrix and the system solved according to a simplex optimization algorithm to determine that, for example, power module 1 is allocated 30 W, power module 2 is allocated 55 W, and power module 3 is allocated 15 W according to the specific example described above.

The algorithm described above is one method that may be used to allocated power among power modules 120 where it is desired to account for things like battery state of the attached devices, and the like. However, the exact method used is not limiting to the system overall, and other allocation methods may be used withing the scope of the disclosure. For example, a simple algorithm may just involve adding a weighted portion of the remainder of available power to each device over the requested minimum power. Further allocation algorithms are also envisioned.

In block 570, the controller 110 implements the power plan by allocating power to each power module as necessary. Implementing the power plan may consist of data send to power modules 120 indicating an amount of power allocated. Further, the controller 110 may control the power output circuits 225 in the controller 110 to set a maximum amount of power that may be drawn by each power module 120.

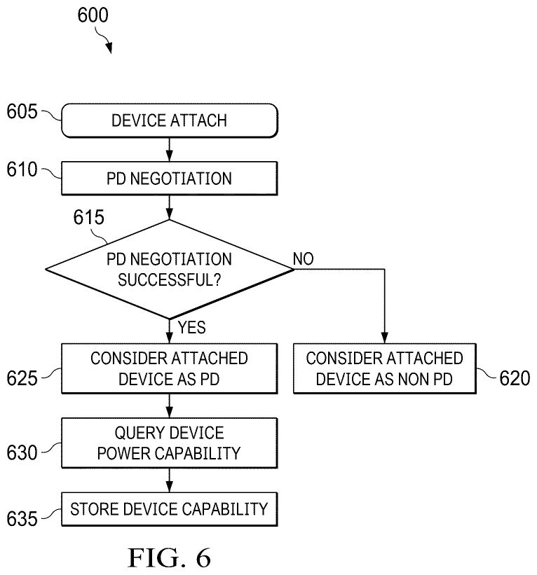

FIG. 6 is a device attachment algorithm 600 executed by a power module 120, in accordance with some embodiments. The device attachment algorithm 600 may execute as a result of a user plugging a device into, for example, charging port 130a, which would trigger the device attachment algorithm 600 to run on power module 120a. For the sake of simplicity, charging ports 130a and power module 120a are utilized to describe the device attachment algorithm 600 in relation to these two devices. However, any power module 120 may execute the device attachment algorithm 600 with a device attached to its correspondingly connected charging port 130.

In block 605, a user attaching a device to, for example, charging port 130a. The connection may be a USB 2.0, USB 3.0, USB-C, Lightning™ connection, or the like. The power module 120a detects the presence of the device through the USB data lines from the power module 120a to charging port 130a. This detection may trigger the power delivery negotiation process in block 610.

In block 610, the power module 120a, will perform a power delivery negotiation with the attached device according to known USB protocols, Lightning™ protocols, or the like. In some cases, a second minimum threshold power may be supplied to the device for a case in which the device has a completely depleted battery before the power deliver negotiation. In some embodiments, the second minimum threshold power may be less than 100 mW. The power deliver negotiation entails the exchange of data over USB data lines between the power module 120a and the user device connected to charging port 130a. The data exchanged may include power requirements, supported charging protocols, the device's maximum power consumption, voltage requirements, and supported charging standards. The power module 120a and user device may negotiate optimal charging parameters including the voltage level and the maximum current that can be provided by the power source. This negotiation ensures that the device receives the appropriate amount of power for efficient charging without exceeding the device's limits or damaging the battery.

In block 615, the power module 120a determines if the power delivery negotiation was successful. If the power delivery negotiation was not successful, the power module 120a will execute block 620 and connect the device as only a data device without power delivery and/or charging features. In some embodiments unsuccessful power negotiation will still allow for a reduced charging limit such as under 15 W for a USB-C device, or 7.5 W for USB 2.0 devices. If the power delivery negotiation was successful, the power module 120a will progress to block 625.

In block 625, the device is marked by the power module as requesting power delivery and/or charging features. Ultimately, whether the user device is connected as a power delivery enabled device will depend on the power allotment available by the controller 110, and a successful power delivery assignment when the controller 110 executes the next iteration of its power allocation method 500.

In block 630, the power module 120a may query the user device for its power capabilities if that information was not previously exchanged during the initial power negotiation. In some embodiments, the power module 120a may send a GET_SINK_CAP message conforming to the USB Power Delivery specification. In some embodiments, the response from the user device may comprise a SINK_CAPABILITIES message conforming to the USB Power Deliver specification. In some embodiments, the power capabilities information may comprise maximum and minimum voltages for the VBUS line, maximum and minimum operating currents, whether the device is a dual-role device, whether the device is USB communications capable, a fast role swap support type, and the like.

In block 635, the power module 120a may store the device capabilities in second memory 320. An initial power request may also be sent to the controller 110 in the process of storing the device capabilities. A power request may comprise the minimum and maximum operating power of the device, in accordance with some embodiments. In some embodiments, a default power request may be used having a default minimum power and a default maximum power. In some embodiments, the default minimum power may be 2.5 W. In some embodiments, the default maximum power may be 60 W.

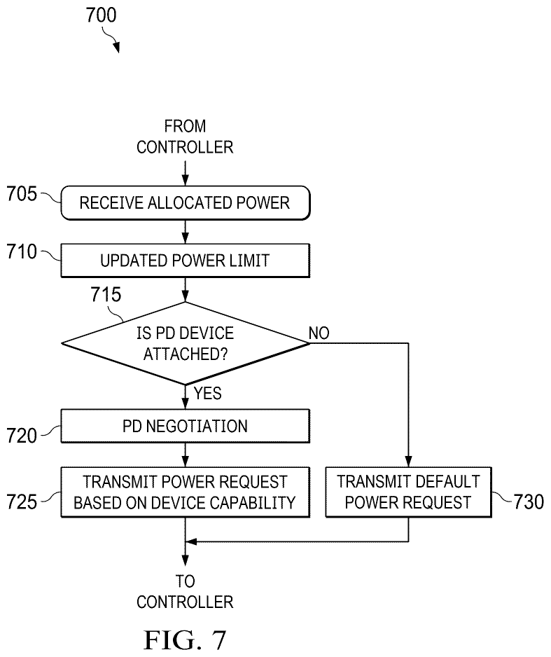

FIG. 7 is an exemplary power delivery and renegotiation algorithm 700 executed by a power module 120, according to some embodiments. In some embodiments, the power delivery and renegotiation algorithm 700 may be executed between the power module 120 and a user device attached through an associated charging port 130, after power has already begun being delivered to the device. In some embodiments, the power delivery and renegotiation algorithm 700 may be initiated at set time intervals. In some embodiments, the user device may initiate the power delivery and renegotiation algorithm 700 by requesting power delivery renegotiation. For the sake of simplicity, charging ports 130a and power module 120a are utilized to describe the power delivery and renegotiation algorithm 700 in relation to these two devices. However, any power module 120 may execute the power delivery and renegotiation algorithm 700 with a device attached to its correspondingly connected charging port 130.

In block 705, the power module 120a receives notification of an allocated power from the controller 110. Notification of allocated power may be the result of the controller 110 executing the power allocation method 500, in accordance with some embodiments.

In block 710, the power module 120a updates a power limit stored in the second memory 320. In some embodiments, the power module 120a may use the updated power limit stored in the second memory for future power delivery negotiations with the controller 110 and/or an attached device.

In block 715, the power module 120a will perform a check to determine if the user device connected through charging port 130a is still connected. If the user device is still connected, then the power module 120a may progress to performing a subsequent power delivery negotiation in block 720. If the user device is not still connected, the power module 120a may progress to block 730 and transmit a default power request, in accordance with some embodiments. In some embodiments, the default power request may include the default minimum power and the default maximum power. In some embodiments, the default minimum power may be 2.5 W. In some embodiments, the default maximum power may be 60 W.

During the charging of the device, both the user device and the power module may monitor, for example, various parameters such as voltage, current, and temperature to ensure safe and efficient charging. If necessary, the charging parameters may need to be adjusted dynamically to accommodate changes in the device's power requirements or environmental conditions. Accordingly, the power module 120a and user device may perform another power delivery negotiation in block 720. This power delivery negotiation may substantially mirror that discussed in relation to block 610 of the device attachment algorithm 600 described above. The power module 120a may then execute block 725, and transmit an updated power request for the user device to the controller 110, based on the new power delivery negotiation.

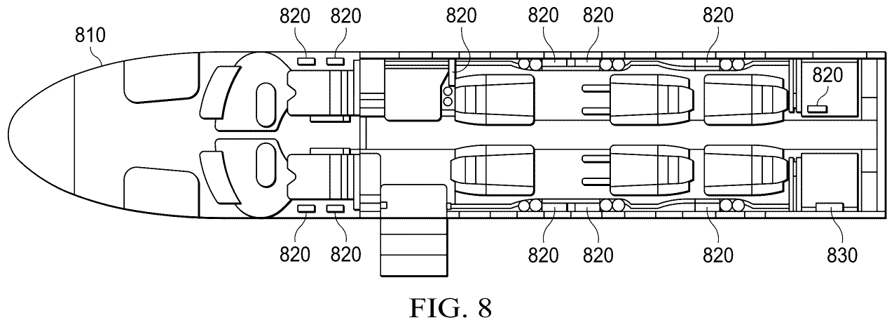

FIG. 8 is an exemplary embodiment showing system 100 installed in an aircraft 810, according to some embodiments. As shown the aircraft 810 may have multiple USB-C power modules 820 installed at various points in the cockpit and cabin of aircraft 810. A USB-C controller 830 may be located in an area easily accessible by the crew. In the embodiment shown, the USB-C controller 830 is located in a clear area across from an emergency exit, devoid of seating, such as a lavatory, or a galley or the like.

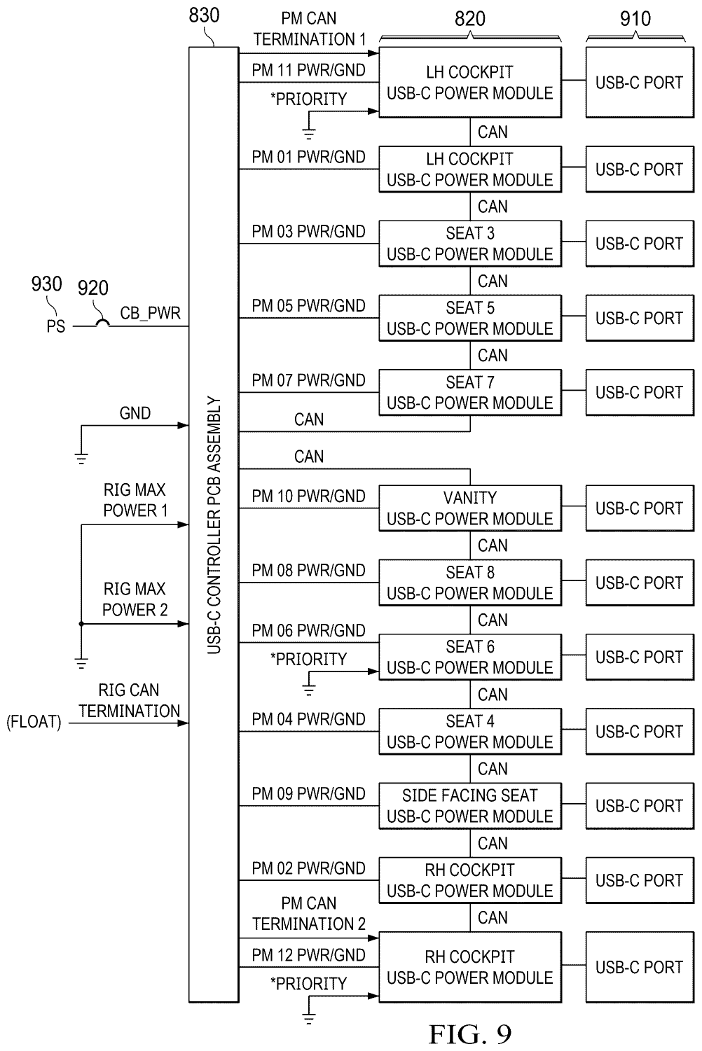

FIG. 9 is an electrical diagram of the exemplary embodiment shown in FIG. 8, according to some embodiments. USB-C controller 830 may take the form of a printed circuit board assembly in accordance with some embodiments. The USB-C controller 830 may have a mainboard and a processing system disposed on the mainboard (not separately shown). The mainboard and processing system may have receptacles such as slots, plugs, pin headers, and the like, for connecting various modules. Further, the mainboard may facilitate the electrical connections between the various system modules and the processing system. The mainboard may include other modules and cabling in some embodiments, such as wired or wireless communication chips, power converters, or the like.

The processing system may include a controller (not shown), with, for example, an expansion board disposed over the controller and associated elements. The expansion board may include connection pins, and one or more connectors for connecting to the controller. The connectors may be, for example, terminal blocks, pin headers, plugs, or the like that permit connection of wires or plugs to the controller for digital and analog inputs and outputs. Additionally, the controller may have more connectors, such as pin headers, solder pads, or the like, for connecting wires, cabling, plugs or the like, for digital or analog inputs and outputs. In some embodiments, the connectors may be for serial bus outputs such as universal asynchronous receiver/transmitter (UART) protocol communication, serial peripheral interface (SPI) protocol communication, inter-integrated circuit (I2C, IIC) protocol communication, controller area network (CAN) bus, or another serial communication protocol.

In some embodiments, the mainboard may include one or more receptacles for providing communication though the mainboard to the controller. For example, the mainboard may have regulator receptacles that accept installation of voltage regulators so that the controller may communicate over a bus to control, for example, a voltage of a digitally controllable voltage regulator. Similarly, the mainboard may include voltage converter receptacles that accept installation of, for example, buck converters and that communicate with the controller via the bus so that the controller can control activation or voltage levels of the installed buck controllers. In some embodiments, the mainboard may have a relay receptacle that accepts installation of a relay board with one or more relays, and that communicates with the controller via the bus so that the controller is able to turn on each relay to turn on or off a voltage being controlled by the respective relay. Other receptacles may be disposed on the mainboard, and may be connected to the controller via the bus so that the controller can control or otherwise communicate with the components installed in the other receptacles.

The receptacles of the mainboard may be designed to securely connect to system modules such that mechanical jarring, for example as occurring during turbulence or wave motion, will not dislodge the system modules from the mainboard. However, the receptacles may allow removal of system modules from the mainboard without requiring solder removal or cutting. Additional fasteners, such as screws, clips, or the like, may be used to further secure the modules to the mainboard in some embodiments.

In other embodiments, receptacles may be mounting structures or regions on the mainboard for attaching components, and the bus may be a cable-based bus where wiring or cabling separate from the mainboard connects the controller or processor to installed components. For example, wires may be used to connect the processor, or sockets, pins, plugs, or the like on the controller to the installed components.

As shown each USB C power module 820 is an individual structure that may be located in proximity to the associated charging port and may having cabling connecting to the USB-C controller 830 comprising a power line and a ground line. Additionally, data lines (in this case a controller area network (CAN) bus) may connect from the USB-C controller 830 to a subset of the USB C power modules 820. In the embodiments shown a first CAN connections run from the USB-C controller 830 to the Seat 7 USB C power module 820, through power modules located at port-side seats, and terminates at the power module for the left-hand (LH) cockpit seat. A second CAN connection runs from the USB-C controller 830, to the vanity (lavatory) USB-C power module, through power modules located at starboard-side seats, and terminates at the right-hand (RH) cockpit USB C power module 820. Accordingly, the CAN bus may be daisy chained through the USB-C controller 830, and all USB-C power modules 820.

Further shown are connections to the grounding plane for the LH cockpit USB C power module, the Seat 6 USB C power module, and the right hand (RH) cockpit USB C power module. In this case these ground connections designate the LH cockpit seat, the RH cockpit seat, and seat number 6 as priority for power delivery. Power from power supply 930 may be supplied to the USB-C controller 830 through a breaker 920. Each USB C power module 820 shown further includes a USB connection to an associated USB-C port 910 for connecting user devices.

In the several embodiments provided in this application, it should be understood that the disclosed system, apparatus, and method may be implemented in other manners. For example, the foregoing apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on an actual requirement to achieve the objectives of the solutions of embodiments of this application.

Functional units in embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of a software function unit and sold or used as an independent product, the integrated unit may be stored in a computer-readable storage medium. Based on such an understanding, the technical solutions of this application essentially, or the part contributing to the conventional technology, or all or some of the technical solutions may be implemented in the form of a software product. The computer software product is stored in a storage medium and includes several instructions for indicating a computer device (which may be a personal computer, a server, a network device, or the like) to perform all or some of the steps of the method described in embodiments of this application. The foregoing storage medium includes any medium that can store program code, such as a USB flash drive, a removable hard disk, a read-only memory (ROM), a random access memory (RAM), a magnetic disk, or an optical disc.

All or some of the foregoing embodiments may be implemented by software, hardware, firmware, or any combination thereof. When software is used to implement embodiments, all or some of the embodiments may be implemented in a form of a computer program product. The computer program product includes one or more computer program instructions. When the computer program instructions are loaded and executed on a computer, all or some of the procedures or functions according to embodiments of this application are generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer program instructions may be transmitted from a website, computer, server, or data center to another website, computer, server, or data center in a wired or wireless manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive), or the like.

In a first embodiments, a modular universal serial bus (USB) charging system is provided, the system including a plurality of power modules, a plurality of charging ports, where each charging port of the plurality of charging ports is connected to a power module of the plurality of power modules, and a controller, where the controller individually and dynamically allocates power to the plurality of power modules.

In some embodiments, each power module of the plurality of power modules is in a one-to-one correspondence to a charging port of the plurality of charging ports. In some embodiments, a subset of power modules of the plurality of power modules are designated as priority power modules, and the controller preferentially allocates power to priority power modules. In some embodiments, each charging port of the plurality of charging ports include at least one of USB 2.0, USB 3.0, or USB-C connections, and where each charging port of the plurality of charging ports is connected to a power module of the plurality of power modules using a USB connection. In some embodiments, the controller includes one or more first processors, at least one first memory connected to the one or more first processors, and storing first computer code, where the at least one first memory and the first computer code are configured, with the one or more first processors, to cause the controller to dynamically allocate power to the plurality of power modules, at least one first power input circuit connected to an input voltage sensing circuit, at least one first direct current-direct current (DC/DC) converter receiving power from the first power input circuit through the input voltage sensing circuit, where the at least one first DC/DC converter supplies a different voltage of power to the one or more first processors, a power output circuit receiving power from the first power input circuit, through the input voltage sensing circuit, that dynamically controls power to the plurality of power modules based on input from the one or more first processors, one or more output current sensing circuits that provide an indication to the one or more first processors of an electric current flow to each power module of the plurality of power modules, and a communication interface for communicating with at least the plurality of power modules. In some embodiments, each power module of the plurality of power modules includes one or more second processors, at least one second memory connected to the one or more second processors, and storing second computer code, where the at least one second memory and the second computer code are configured, with the one or more second processors, to cause the power modules to perform power delivery negotiation with a user device when connected to the power modules through a charging port of the plurality of charging ports, and communicate with the controller with respect to power delivery to the user device, the power module further including at least one second power input circuit, at least one second DC/DC converter receiving power from the second power input circuit, where the at least one second DC/DC converter supplies a different voltage of power to the one or more second processors, at least one load switch, receiving power from the at least one second DC/DC converter, that switches power to a user device based on input from the one or more second processors, a communication interface for communicating with at least the user device and the controller. In some embodiments, the power module further includes an input to the controller for identifying the power modules as a priority power module receiving priority power allocation from the controller.

In a second embodiment, a universal serial bus (USB) power allocation method is provided, the method including starting, by a controller, a first timer for a first time period, determining if a first input voltage is sufficient to provide a first output threshold voltage, setting a maximum power value for a first power module of a plurality of power modules, based on determining that the first input voltage is not sufficient to provide a first output threshold voltage, to the minimum of either a requested maximum power received in a power request from a first power module of a plurality of power modules or a first default maximum power, setting a maximum power value for the first power module of the plurality of power modules, based on determining that the first input voltage is sufficient to provide a first output threshold voltage, to the requested maximum power received in the power request from the first power module, and generating a power allocation plan based on an available amount of power, a set maximum power value for the first power module of the plurality of power modules, and a set minimum power value for the first power module of the plurality of power modules, and delivering power to the first power module based on the power allocation plan.

In some embodiments, the controller executes the power allocation method again at an expiration of the first time period. In some embodiments, the method further includes receiving, by a controller, at least one power request from the first power module of the plurality of power modules, and storing, by the controller, the at least one power request in a first memory. In some embodiments, the set minimum power value for the first power module is a minimum of a minimum power in the power request, or a first default maximum power value. In some embodiments, the controller receives a power requests from a plurality of power modules, the controller sets the maximum power value and the minimum power value for each of the power modules receiving the request in a same manner as the maximum power value and minimum power value for the first power module, and the method further includes summing the set maximum power values of the plurality of power modules, and comparing the sum of the set maximum power values to the available amount of power, and where generating the power allocation plan includes allocating the set maximum power to each power module of the plurality of power modules based on a determining the sum of the set maximum power values is smaller than or equal to the available amount of power. In some embodiments, generating the power allocation plan includes allocating power between the set maximum power and set minimum power value to each power module of the plurality of power modules, based on a determining the sum of the set maximum power values is greater than the available amount of power. In some embodiments, the method further includes, based on a sum of the set minimum power values for each power module of the plurality of power modules being greater than the available amount of power, before generating the power allocation plan performing changing the set minimum power value for each power module not designated as priority to a first minimum threshold power, and changing the set minimum power value for each power module designated as priority to one of the minimum requested power or a second minimum threshold power, where the first minimum threshold power is less than the second minimum threshold power.

In a third embodiment, an aircraft is provided, the aircraft including a plurality of universal serial bus (USB) power modules, a plurality of USB charging ports, where each USB charging port of the plurality of USB charging ports is communicatively and electrically connected to a USB power module of a plurality of USB power modules, where at least a subset of USB charging ports of the plurality of USB charging ports are installed in the aircraft at locations accessible by a passenger or crew of the aircraft, and a controller, where the controller individually and dynamically allocates power to the plurality of USB power modules.

In some embodiments, USB power modules connected to USB charging ports located in a cockpit of the aircraft are designated as priority USB power modules and priority USB power modules receive preferential priority to allocated power when demand from all connected power modules exceeds an amount of power available to the controller. In some embodiments, the controller receives power from a DC power bus in the aircraft, and where each of the USB power modules receives power from the controller based on a dynamically generated power plan. In some embodiments, the dynamically generated power plan allocates power to each USB power module based on an amount of power available to the controller, and a maximum power and minimum power received by the controller in a power request from at least one USB power module. In some embodiments, the controller includes one or more output voltage circuits controlled by a first processor that are configured to provide power to a USB power module based on the dynamically generated power plan. In some embodiments, the controller includes one or more processors, and at least one non-transitory computer readable memory connected to the one or more processors and including computer code, where the at least one non-transitory computer readable memory and the computer code are configured, with the one or more processors, to cause the controller to at least: start a first timer for a first time period; determine if a first input voltage is sufficient to provide a first output threshold voltage; set a maximum power value for a first USB power module of the plurality of USB power modules, based on determining that the first input voltage is not sufficient to provide a first output threshold voltage, to the minimum of a requested maximum power received in a power request from the first USB power module of a plurality of USB power modules or a first default maximum power; set a maximum power value for the first USB power module of the plurality of USB power modules, based on determining that the first input voltage is sufficient to provide a first output threshold voltage, to the requested maximum power received in the power request from the first USB power module; and generate a power allocation plan based on an available amount of power, a set maximum power value for the first USB power module of the plurality of USB power modules, and a set minimum power value for the first USB power module of the plurality of USB power modules; and deliver power to the first USB power module based on the power allocation plan.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A modular universal serial bus (USB) charging system, comprising:
a plurality of power modules;
a plurality of charging ports, wherein each charging port of the plurality of charging ports is connected to a power module of the plurality of power modules; and
a controller, wherein the controller individually and dynamically allocates power to the plurality of power modules.

2. The modular USB charging system of claim 1, wherein each power module of the plurality of power modules is in a one-to-one correspondence to a charging port of the plurality of charging ports.

3. The modular USB charging system of claim 1, wherein a subset of power modules of the plurality of power modules are designated as priority power modules, and the controller preferentially allocates power to priority power modules.

4. The modular USB charging system of claim 1, wherein each charging port of the plurality of charging ports comprise at least one of USB 2.0, USB 3.0, or USB-C connections, and wherein each charging port of the plurality of charging ports is connected to a power module of the plurality of power modules using a USB connection.

5. The modular USB charging system of claim 1, wherein the controller comprises:
one or more first processors;
at least one first memory connected to the one or more first processors, and storing first computer code, wherein the at least one first memory and the first computer code are configured, with the one or more first processors, to cause the controller to dynamically allocate power to the plurality of power modules;
at least one first power input circuit connected to an input voltage sensing circuit;
at least one first direct current-direct current (DC/DC) converter receiving power from the first power input circuit through the input voltage sensing circuit, wherein the at least one first DC/DC converter supplies a different voltage of power to the one or more first processors;
a power output circuit receiving power from the first power input circuit, through the input voltage sensing circuit, that dynamically controls power to the plurality of power modules based on input from the one or more first processors;
one or more output current sensing circuits that provide an indication to the one or more first processors of an electric current flow to each power module of the plurality of power modules; and
a communication interface for communicating with at least the plurality of power modules.

6. The modular USB charging system of claim 1, wherein each power module of the plurality of power modules comprises:
one or more second processors;
at least one second memory connected to the one or more second processors, and storing second computer code, wherein the at least one second memory and the second computer code are configured, with the one or more second processors, to cause the power modules to perform power delivery negotiation with a user device when connected to the power modules through a charging port of the plurality of charging ports, and communicate with the controller with respect to power delivery to the user device;
at least one second power input circuit;
at least one second DC/DC converter receiving power from the second power input circuit, wherein the at least one second DC/DC converter supplies a different voltage of power to the one or more second processors;
at least one load switch, receiving power from the at least one second DC/DC converter, that switches power to a user device based on input from the one or more second processors;
a communication interface for communicating with at least the user device and the controller.

7. The modular USB charging system of claim 6, wherein the power module further includes an input to the controller for identifying the power modules as a priority power module receiving priority power allocation from the controller.

8. A universal serial bus (USB) power allocation method, comprising:
starting, by a controller, a first timer for a first time period;
determining if a first input voltage is sufficient to provide a first output threshold voltage;
setting a maximum power value for a first power module of a plurality of power modules, based on determining that the first input voltage is not sufficient to provide a first output threshold voltage, to the minimum of:
a requested maximum power received in a power request from a first power module of a plurality of power modules; or
a first default maximum power;
setting a maximum power value for the first power module of the plurality of power modules, based on determining that the first input voltage is sufficient to provide a first output threshold voltage, to the requested maximum power received in the power request from the first power module; and
generating a power allocation plan based on an available amount of power, a set maximum power value for the first power module of the plurality of power modules, and a set minimum power value for the first power module of the plurality of power modules; and
delivering power to the first power module based on the power allocation plan.

9. The USB power allocation method of claim 8, wherein the controller executes the power allocation method again at an expiration of the first time period.

10. The USB power allocation method of claim 8, wherein the method further comprises:
receiving, by a controller, at least one power request from the first power module of the plurality of power modules; and
storing, by the controller, the at least one power request in a first memory.

11. The USB power allocation method of claim 10, wherein the set minimum power value for the first power module is a minimum of:
a minimum power in the power request; or
a first default maximum power value.

12. The USB power allocation method of claim 11, wherein:
the controller receives a power requests from a plurality of power modules;
the controller sets the maximum power value and the minimum power value for each of the power modules receiving the request in a same manner as the maximum power value and minimum power value for the first power module; and
wherein the method further comprises:
summing the set maximum power values of the plurality of power modules; and
comparing the sum of the set maximum power values to the available amount of power; and
wherein generating the power allocation plan comprises allocating the set maximum power to each power module of the plurality of power modules based on a determining the sum of the set maximum power values is smaller than or equal to the available amount of power.

13. The USB power allocation method of claim 12, wherein generating the power allocation plan comprises allocating power between the set maximum power and set minimum power value to each power module of the plurality of power modules, based on a determining the sum of the set maximum power values is greater than the available amount of power.

14. The USB power allocation method of claim 13, wherein the method further comprises, based on a sum of the set minimum power values for each power module of the plurality of power modules being greater than the available amount of power, before generating the power allocation plan performing:
changing the set minimum power value for each power module not designated as priority to a first minimum threshold power; and
changing the set minimum power value for each power module designated as priority to one of:
the minimum requested power; or
a second minimum threshold power;
wherein the first minimum threshold power is less than the second minimum threshold power.

15. An aircraft, comprising:
a plurality of universal serial bus (USB) power modules;
a plurality of USB charging ports, wherein each USB charging port of the plurality of USB charging ports is communicatively and electrically connected to a USB power module of a plurality of USB power modules, wherein at least a subset of USB charging ports of the plurality of USB charging ports are installed in the aircraft at locations accessible by a passenger or crew of the aircraft; and
a controller, wherein the controller individually and dynamically allocates power to the plurality of USB power modules.

16. The aircraft of claim 15, wherein USB power modules connected to USB charging ports located in a cockpit of the aircraft are designated as priority USB power modules; and wherein priority USB power modules receive preferential priority to allocated power when demand from all connected power modules exceeds an amount of power available to the controller.

17. The aircraft of claim 15, wherein the controller receives power from a DC power bus in the aircraft, and wherein each of the USB power modules receives power from the controller based on a dynamically generated power plan.

18. The aircraft of claim 17, wherein the dynamically generated power plan allocates power to each USB power module based on an amount of power available to the controller, and a maximum power and minimum power received by the controller in a power request from at least one USB power module.

19. The aircraft of claim 18, wherein the controller comprises one or more output voltage circuits controlled by a first processor that are configured to provide power to a USB power module based on the dynamically generated power plan.

20. The aircraft of claim 15, wherein the controller comprises:
one or more processors; and
at least one non-transitory computer readable memory connected to the one or more processors and including computer code, wherein the at least one non-transitory computer readable memory and the computer code are configured, with the one or more processors, to cause the controller to at least:
start a first timer for a first time period;
determine if a first input voltage is sufficient to provide a first output threshold voltage;
set a maximum power value for a first USB power module of the plurality of USB power modules, based on determining that the first input voltage is not sufficient to provide a first output threshold voltage, to the minimum of:
a requested maximum power received in a power request from the first USB power module of a plurality of USB power modules; or
a first default maximum power;
set a maximum power value for the first USB power module of the plurality of USB power modules, based on determining that the first input voltage is sufficient to provide a first output threshold voltage, to the requested maximum power received in the power request from the first USB power module; and
generate a power allocation plan based on an available amount of power, a set maximum power value for the first USB power module of the plurality of USB power modules, and a set minimum power value for the first USB power module of the plurality of USB power modules; and
deliver power to the first USB power module based on the power allocation plan.
